(19) United States
(12) Patent Application Publication
(10) Pub. No.: US 2013/0235262 A1
(43) Pub. Date: Sep. 12, 2013

(54) METHOD FOR PACKAGING IMAGE SENSOR STRUCTURE AND IMAGE SENSOR STRUCTURE FORMED FROM THE SAME

(71) Applicant: Allen Chao, Taichung City (TW)

(72) Inventor: Allen Chao, Taichung City (TW)

(21) Appl. No.: 13/417,339

(22) Filed: Mar. 12, 2012

(51) Int. Cl. H04N 5/225

(52) U.S. Cl. 348/374; 348/E05.026

(57) ABSTRACT

A method for packaging an image sensor structure and an image sensor structure formed from the same are provided. The method comprises the steps of: providing an image sensor set on a substrate in that: a plurality of substrate conductive joints are installed on the supporting surface; adhering a transparent cover upon the image sensor set; taking a needle with adhesive therein; preferably, the adhesive is epoxy; injecting the adhesive from the needle into a periphery of the image sensor set and the transparent cover to completely seal the sensor conductive joints, the substrate conductive joints and conductive wires between the substrate conductive joints and the sensor conductive joints so as to package the image sensor set therein and form a packaging structure; and baking the packaging structure. An image sensor structure made from the same is provided.

### FIELD OF THE INVENTION

The present invention relates to image sensor packaging, in particular to a method for packaging an image sensor structure and the image sensor structure formed from the same.

### DESCRIPTION OF THE PRIOR ART

Conventionally, the process for packaging image sensor set contains the steps of: providing an image sensor set on a substrate; adhering a transparent cover upon the image sensor set by installing a gluing frame therebetween for protecting the image sensor set; the gluing frame being installed near edges of the transparent cover for fixing the transparent cover to the image sensor set; providing a dam bar at an upper periphery of the transparent cover; then above mentioned structure is placed into a mold (including an upper mold and a lower mold) with a hollow portion within the mold being filled with adhesive (preferably, epoxy). After baking, the mold is released from the structure so that the epoxy is filled on the periphery of the image sensor set and the transparent cover to completely seal the sensor conductive joints, the substrate conductive joints and the conductive wires between the sensor conductive joints and the substrate conductive joints so as to package the image sensor set therein and form a packaging structure.

This prior art manufacturing method need dam bars and molds so that the whole works are complicated and more cost is needed.

### SUMMARY OF THE INVENTION

The present invention relates to a method for packaging an image sensor structure and an image sensor structure formed from the same, in that the manufactured step is simplified. No mold is used and No dam bar is used. The overall manufacturing cost is low.

To achieve above object, the present invention provides a method for packaging an image sensor structure. The method comprises the steps of: providing an image sensor set on a substrate in that: a plurality of substrate conductive joints are installed on the supporting surface; a gluing layer being formed between the substrate and the image sensor set for fixing the image sensor set to the substrate; adhering a transparent cover upon the image sensor set by installing a gluing frame therebetween for protecting the image sensor set; the gluing frame being installed near edges of the transparent cover for fixing the transparent cover to the image sensor set; providing a needle with adhesive therein; preferably, the adhesive is epoxy; injecting the adhesive from the needle into a periphery of the image sensor set and the transparent cover to completely seal the sensor conductive joints, the substrate conductive joints and conductive wires between the substrate conductive joints and the sensor conductive joints so as to package the image sensor set therein and form a packaging structure; and baking the packaging structure.

Moreover, the present invention provides an image sensor structure formed from the same which is formed from the above mentioned method.

The various objects and advantages of the present invention will be more readily understood from the following detailed description when read in conjunction with the appended drawing.

### BRIEF DESCRIPTION OF THE DRAWINGS

FIG. 1 is a cross sectional view of the present invention.

FIG. 2 is a cross sectional view showing the application of the present invention.

FIG. 3 is a cross sectional view showing the application of the present invention.

FIG. 4 is an elevational view of the present invention.

FIG. 5 shows the flow diagram of the present invention.

### DETAILED DESCRIPTION OF THE IVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

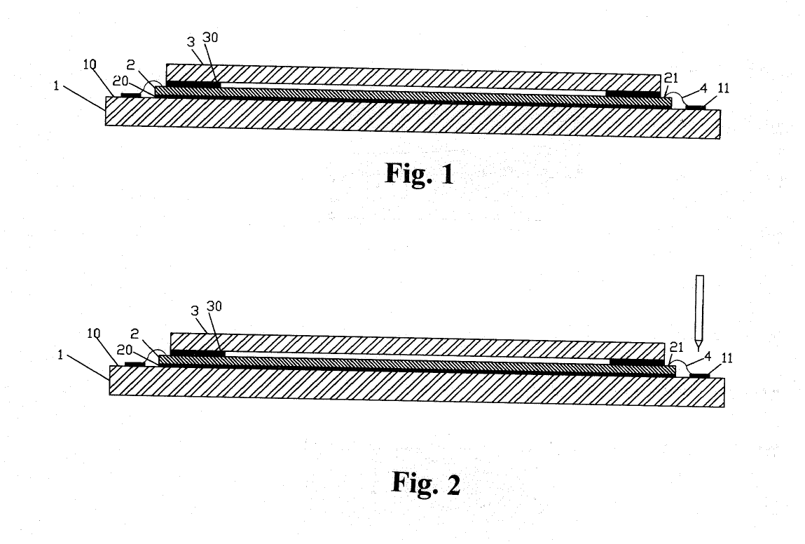

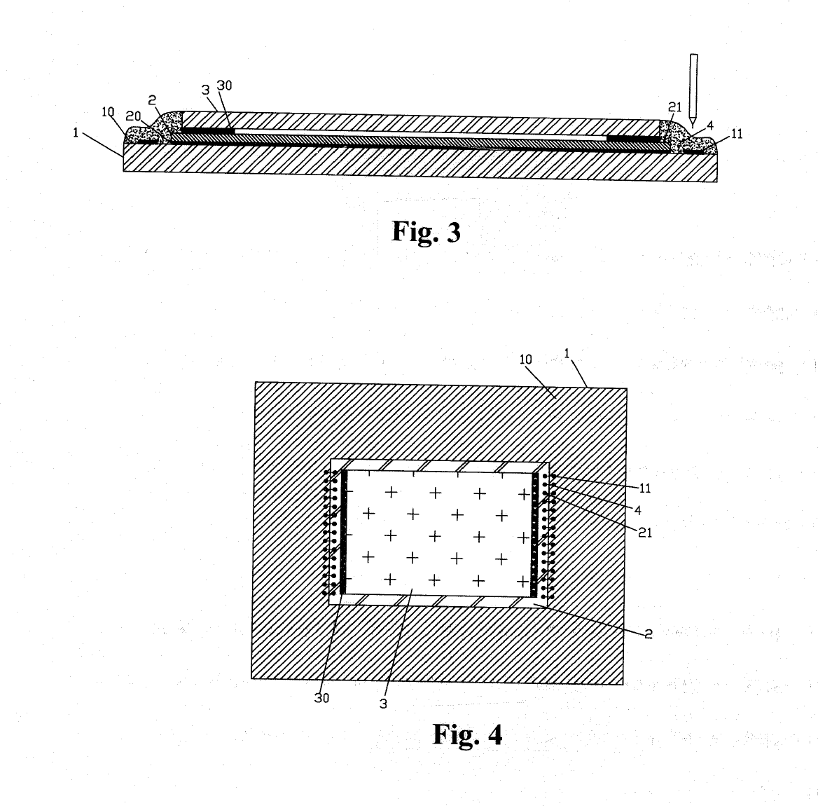

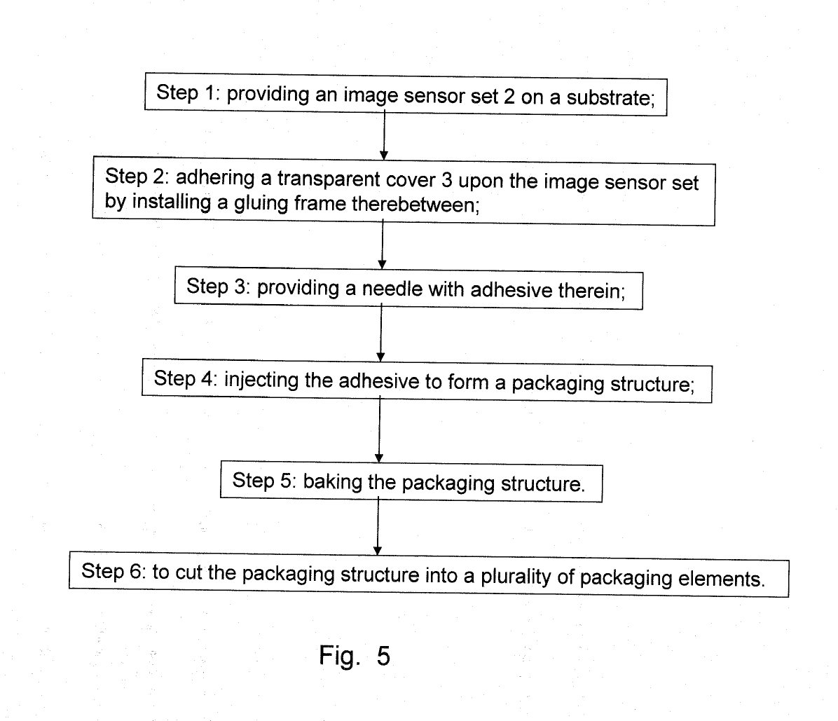

Referring to FIGS. 1 to 5, the structure of the present invention is illustrated. The present invention has the following elements.

A substrate 1 is for example a circuit substrate 1. The substrate 1 has a supporting surface 10 for locating other elements. A plurality of substrate conductive joints 11 are installed on the supporting surface 10.

An image sensor set 2 serves for sensing light and transferring signals to the substrate 1. The image sensors in the image sensor set 2 may be CCD (Charged Couple Device) or CMOS (Complementary Metal Oxide Semiconductor). A gluing layer 20 is formed between the substrate 1 and the image sensor set 2 for fixing the image sensor set 2 to the substrate 1.

The image sensor set 2 is formed with a plurality of sensor conductive joints 21.

A transparent cover 3 is installed upon the image sensor set 2 for protecting the image sensor set 2. Light can radiate through the transparent cover 3 to the image sensor set 2. A gluing frame 30 is formed between the transparent cover 3 and the image sensor set 2. The gluing frame 30 is installed near edges of the transparent cover 3 for fixing the transparent cover 3 to the image sensor set 2.

A plurality of conductive wires 4 are connected between the senor conductive joints 21 and the substrate conductive joints 11 for signal conduction between the image sensor set 2 and the substrate 1.

The packaging way of the present invention including the following steps of:

Step 1: providing an image sensor set 2 on a substrate;

Step 2: adhering a transparent cover 3 upon the image sensor set 2 by installing a gluing frame 30 therebetween for protecting the image sensor set 2; the gluing frame 30 being installed near edges of the transparent cover 3 for fixing the transparent cover 3 to the image sensor set 2;

Step 3: providing a needle with adhesive therein; preferably, the adhesive is epoxy;

Step 4: injecting the adhesive from the needle into a periphery of the image sensor set 2 and the transparent cover 3 to completely seal the sensor conductive joints 21, the substrate conductive joints 11 and the conductive wires so as to package the image sensor set therein and form a packaging structure;

Step 5: baking the packaging structure.

It should be noted that in the present invention, the image sensor set 2 may contain only one image sensor or a plurality of image sensors. If the image sensor set 2 contains a plurality of image sensors. A further step (step 6) is to cut the packaging structure into a plurality of packaging elements, in that each packaging element contains only one image sensor.

Advantages of the present invention are that: the manufactured step is simplified. No mold is used and No dam bar is used. The overall manufacturing cost is low.

The present invention is thus described, it will be obvious that the same may be varied in many ways. For example, the slot 11, 12 can be formed directly to the pillar; the pushing head 46 of the tightening unit 4 can be formed like a saddle capable of sitting across the water blocking sheet for better stability. Such variations are not to be regarded as a departure from the spirit and scope of the present invention, and all such modifications as would be obvious to one skilled in the art are intended to be included within the scope of the following claims.

What is claimed is:

1. A method for packaging an image sensor structure, comprising the steps of:
providing an image sensor set on a substrate, in that: a plurality of substrate conductive joints are installed on the supporting surface; a gluing layer being formed between the substrate and the image sensor set for fixing the image sensor set to the substrate;
adhering a transparent cover upon the image sensor set by installing a gluing frame therebetween for protecting the image sensor set; the gluing frame being installed near edges of the transparent cover for fixing the transparent cover to the image sensor set;
taking a needle with adhesive therein; preferably, the adhesive is epoxy;
injecting the adhesive from the needle into a periphery of the image sensor set and the transparent cover to completely seal the sensor conductive joints, the substrate conductive joints and conductive wires between the substrate conductive joints and the sensor conductive joints so as to package the image sensor set therein and form a packaging structure; and
baking the packaging structure.

2. The method for packaging an image sensor structure as claimed in claim 1, wherein the image sensor contain only one image sensor.

3. The method for packaging an image sensor structure as claimed in claim 1, wherein the image sensor set contains a plurality of image sensors; and after baking, the packaging structure is cut into a plurality of packaging elements, in that each packaging element contains only one image sensor.

4. The method for packaging an image sensor structure as claimed in claim 1, wherein the adhesive is epoxy.

5. The method for packaging an image sensor structure as claimed in claim 1, wherein the image sensors are CCD (Charged Couple Device) or CMOS (Complementary Metal Oxide Semiconductor).

6. An image sensor packaging structure, comprising:
a substrate having a supporting surface; a plurality of substrate conductive joints being installed on the supporting surface;
an image sensor set for sensing light and transferring signals to the substrate; a gluing layer being formed between the substrate and the image sensor set for fixing the image sensor set to the substrate; the image sensor set being formed with a plurality of sensor conductive joints;
a transparent cover installed upon the image sensor set for protecting the image sensor set; light can radiate through the transparent cover to the image sensor set; a gluing frame being formed between the transparent cover and the image sensor set; the gluing frame being installed near edges of the transparent cover; for fixing the transparent cover to the image sensor set;
a plurality of conductive wires connected between the senor conductive joints and the substrate conductive joints for signal conduction between the image sensor set and the substrate; and
a packaging adhesive enclosure on a periphery of the image sensor set and the transparent cover to completely seal the sensor conductive joints, the substrate conductive joints and conductive wires between the substrate conductive joints and the sensor conductive joints to package the image sensor set therein and form a packaging structure;

7. The image sensor packaging structure as claimed in claim 1, wherein the image sensor contain only one image sensor.

8. The image sensor packaging structure as claimed in claim 1, wherein the image sensor set contains a plurality of image sensors; and after baking, the packaging structure is cut into a plurality of packaging elements, in that each packaging element contains only one image sensor.

9. The image sensor packaging structure as claimed in claim 1, wherein the adhesive is epoxy.

10. The image sensor packaging structure as claimed in claim 1, wherein the image sensors are CCD (Charged Couple Device) or CMOS (Complementary Metal Oxide Semiconductor).
